(19) United States
(12) Patent Application Publication
(10) Pub. No.: US 2003/0164440 A1
(43) Pub. Date: Sep. 4, 2003

(54) Autofocussing device for optical instruments

(76) Inventors: Nobert Czarnetzki, Jena (DE); Stefan Mack, Freiburg (DE); Thomas Scheruebl, Jena (DE)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 10/276,446

(22) PCT Filed: May 11, 2001
(86) PCT No.: PCT/EP01/05388

(30) Foreign Application Priority Data
May 18, 2000 (DE) 100 24 687.7

(51) Int. Cl. G02B 7/04

(52) U.S. Cl. 250/201.3

(57) ABSTRACT

The invention is directed to an autofocusing device, preferably for microscopes for wafer inspection, in which a point-shaped illumination diaphragm (1) which is illuminated by laser light is imaged in an observed object (5). An image of the point illuminated on the observed object (5) is formed in a measurement diaphragm arrangement conjugate to the illumination diaphragm (1), the position of maximum intensity of this image is determined by a position-sensitive detector (11) and this position is compared to a position corresponding to the focus position, and an actuating signal for autofocusing is obtained from the deviation between the two positions. In an autofocusing device of the type described above, the measurement diaphragm arrangement comprises a plurality of optically active components which are arranged one behind the other in axial direction and have partially transparent and partially opaque structures which complement one another, and the components are arranged in the beam path in front of and behind the position conjugate to the illumination diaphragm (1) within a distance from one another corresponding to the depth of focus. The cross section of the light beam coming from the observed object (5) is blocked by the structures to a greater or lesser extent depending on the position of the observed object (5).

The invention is directed to an autofocusing device for optical instruments, preferably for microscopes for wafer inspection, in which a point-shaped illumination diaphragm which is illuminated by laser light is imaged in an observed object by means of an imaging objective, wherein an image of the point illuminated on the observed object is formed in a measurement diaphragm arrangement conjugate to the illumination diaphragm, the position of maximum intensity of this image is determined by a position-sensitive detector and this position is compared to a position corresponding to the focus position, and an actuating signal for autofocusing is obtained from the deviation between the two positions.

For precise measurement of distances and, in connection with this, also for the purpose of focusing the microscope imaging on a specimen to be examined, there are currently essentially the following known methods which can be classed as follows:

imaging methods with contrast evaluation and stripe projection methods;

triangulation methods;

laser autofocus methods; and

confocal methods.

Imaging methods and accompanying arrangements in which measurement values are determined by contrast evaluation of the light reflected from a surface involve extensive computation for image processing and, moreover, work-relatively slowly. Further, they do not supply a direction signal for a deliberate actuating movement for purposes of correcting the focus position.

While triangulation methods have a relatively large capture area, they are limited to approximately 300 nm with respect to the resolution in coordinate Z. Systems working on the basis of this method must be laboriously adjusted because the measurement beam extends extra-axially.

Laser autofocus methods are used, for example, in CD players. They offer a large capture area with high Z-resolution. Moreover, they supply signals from which the direction of the actuating movement in which refocusing is to be carried out can be derived. However, experiences with systems of this type show that the Z-resolution is only usable when the surface to be measured possesses ideal reflection characteristics. A laser autofocus sensor no longer achieves this advantageous high Z-resolution on coated surfaces which reflect the incident light in two or more planes. Systematic measurement errors occur whose magnitude, moreover, has a nonlinear dependence upon the layer thickness and layer materials.

The present invention belongs in the field of confocal methods.

An arrangement working with a confocal method is described, for example, in DE 19511937 C2. Microstructures can be imaged and measured even in different planes of the surface of an observed object with this arrangement. However, it is disadvantageous that the capture area is relatively small; also, no direction signal is supplied for automatic focusing.

In coated surfaces generating two or more light reflections, systematic measurement errors result whose magnitude depends nonlinearly on the layer thicknesses and layer materials, so that the resolution in Z-direction is reduced in an unwanted manner.

Due to the fact that chip fabrication in particular aims at increasingly finer structures and thinner layers, the requirements imposed on the inspection methods for checking manufacturing accuracy are also increasingly stricter, which inevitably leads to the demand for faster and more accurate focusing during the fabrication process.

On this basis, it is the object of the invention to further develop an arrangement for confocal autofocusing of optical instruments, preferably for microscopic wafer inspection, in such a way that a direction signal can be obtained for focusing and, therefore, a fast and reliable readjustment of the focus can be brought about while retaining a high Z-resolution and high measurement speed over a large capture area.

According to the invention, in an autofocusing device of the type described in the beginning, a measurement diaphragm arrangement comprises a plurality of optically active components which are arranged one behind the other in axial direction and have partially transparent and partially opaque structures which complement one another, wherein the components are arranged in the beam path in front of and behind the position conjugate to the illumination diaphragm within a distance from one another corresponding to the depth of focus, wherein the cross section of the light beam coming from the observed object is blocked by the structures to a greater or lesser extent depending on the position of the observed object, and therefore the intensity of the image on the detector has a definite distribution when the deviation in position approaches zero or when the observed object is located in the focus position.

When a plurality of components of the type described above having partially transparent and partially opaque structures which complement one another are arranged successively in the detection beam path at a determined axial distance from one another, each of these structures together with the point light source forms a separate confocal sensor. In this connection, a focus position is associated with each sensor.

When the axial distance of the components or structures relative to one another is selected in such a way that the corresponding capture areas overlap, a capture area is achieved which becomes increasingly larger as the quantity of components arranged one behind the other increases.

In an advantageous construction of the invention, two components are provided, each of which has a circular structure having the size of a point-shaped diaphragm or pinhole, whose centers lie in the optical axis, wherein the structures of the two components are transparent and the area surrounding the structures is opaque.

These structures form two so-called inverted pinholes. In this way, the detection beam is completely blocked whenever one of the structures is conjugate to the point light source. On the other hand, the detection beam reaches the reception surface of the detector with maximum intensity when the conjugation to the point light source is located at exactly half of the distance between the two inverted pinholes that are arranged one behind the other. Conversely, this means that the reference focus position is achieved when the detector in the arrangement according to the invention registers at a predetermined location the maximum intensity of the image of the point illuminated on the observed object, because the conjugation then lies exactly between the two inverted pinholes.

In a particularly preferred construction of the invention, two components are provided, each of which has a circular structure having the size of a point-shaped diaphragm or pinhole, whose centers lie in the optical axis, wherein a half-circle of each of these structures is transparent and the second half-circle of each of these structures is opaque, and wherein the structures are rotated by 180° about the optical axis from one component to the next.

The reference focus position is also achieved in this case when the detector registers the maximum intensity at a predetermined location, since the conjugation to the point light source is then located at exactly half of the distance between the two structures that are arranged one behind the other. However, the center of gravity of the light spot on the detector or the location of the maximum intensity will change in one direction or the other on the detector surface depending on defocusing because the conjugation is displaced toward one or the other of the two structures and one half of the beam or the other is accordingly blocked by one opaque half-circle or the other.

As the maximum drifts in one direction or the other, a position-sensitive detector supplies a difference signal which is further processed, according to the invention, to form the actuating signal for refocusing. This signal is converted into a direction signal for focusing by the evaluating unit communicating with the detector.

In another preferred construction, four components are provided, each of which has a circular structure having the size of a point-shaped diaphragm or pinhole, whose centers lie in the optical axis, wherein one half-circle of each of these structures is transparent and one half-circle is opaque, and wherein the structures are rotated by 90° about the optical axis from component to component.

With an arrangement of this kind, the capture area is advantageously expanded; however, a somewhat greater expenditure on adjustment must be tolerated due to the multiplicity of components to be positioned in the beam path.

In order to avoid this, in another construction, only two components are provided, each of which has a half-circular structure having the size of a half-pinhole but also has, in addition, two quarter-circle segments located diametrically opposite one another with respect to the optical axis, wherein the circle centers of all of the structures always lie in the optical axis, and wherein the quarter-circle segments are rotated by 90° about the optical axis from one component to the next.

Depending on the focus position, greater proportions of the light striking the detector are blocked by the quarter-circle segments that are additionally provided as structures, so that additional information is obtained about the focusing state particularly when the extent of defocusing is greater than the capture area associated with the half-circular structures. Therefore, the same advantages that were achieved with four components are achieved in this case without increased expenditure on adjustment.

When a four-quadrant receiver is used as detector, actuating signals for a coarse focusing can be obtained, for example, from deviations of the maximum of the light spot in direction of a first of two orthogonal directions and actuating signals for fine focusing can be obtained from deviations in the second direction.

The position of the structures on the first component is complementary to the position of the structures on the second component. Instead of circular structures, circular segment-shaped structures which are likewise positioned in the manner described above can also be located in the centers of the components.

The direction signal required for focusing is determined extrafocally or intrafocally based on the division of the light flow to the quadrant pairs. In case of identical or at least similar reflection conditions in the observed object, the light flow which is measurable in the individual quadrants of a four-quadrant receiver is a measurement for the magnitude of the necessary focus readjustment.

In further developments, the structures are formed on the components in the shape of prisms and/or gratings. In special cases, moreover, it is advantageous when the structures are formed differently with respect to their polarization behavior and/or spectral behavior, so that the spectrum or polarization state can be detected additionally by a suitable detector.

Depending upon the application, it may be useful to arrange a plurality of structures in arrays on the components. In this way, a plurality of measurement points can be detected on an observed object simultaneously. In this case, a CCD matrix would be used as a receiver.

In connection with the correction of the focus position, the signal outputs of the detector are connected, via an evaluating unit, to an actuating device for changing the position of the observed object in the Z-coordinate and, accordingly, for correcting the focus position.

A field lens is preferably arranged between the optical elements and the detector in order to make optimal use of the light-sensitive reception surface of the detector.

In another, likewise preferable construction of the invention, the measurement diaphragm arrangement is arranged so as to be displaceable in direction of the optical axis and, for this purpose, has an adjusting device which is driven manually or by motor, preferably by a stepping motor in the latter case. Accordingly, an offset can be generated in that the autofocusing is carried out on a plane lying outside of the observed location O. In this way, boundary layers which are better suited than the location O to be observed because of their optical characteristics can be used within a specimen for autofocusing.

The invention will be described more fully in the following with reference to an embodiment example. In the accompanying drawings:

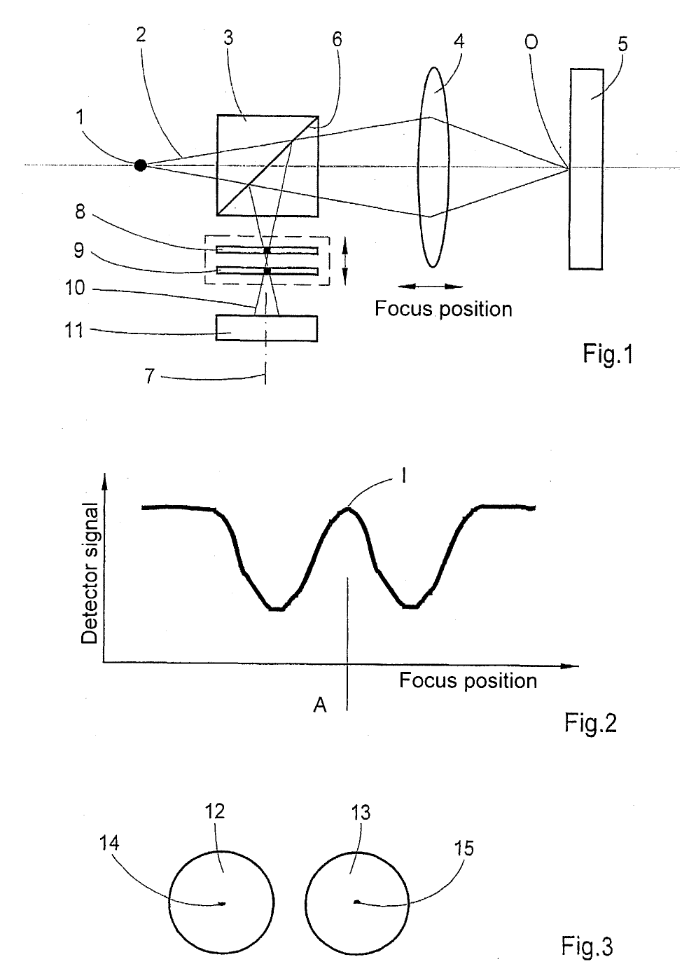

FIG. 1 shows the basic construction of the arrangement using two inverted pinholes;

FIG. 2 shows the detector signal as a function of the focus position using two inverted pinholes;

FIG. 3 shows the shape of two optically active components with half-circular structures;

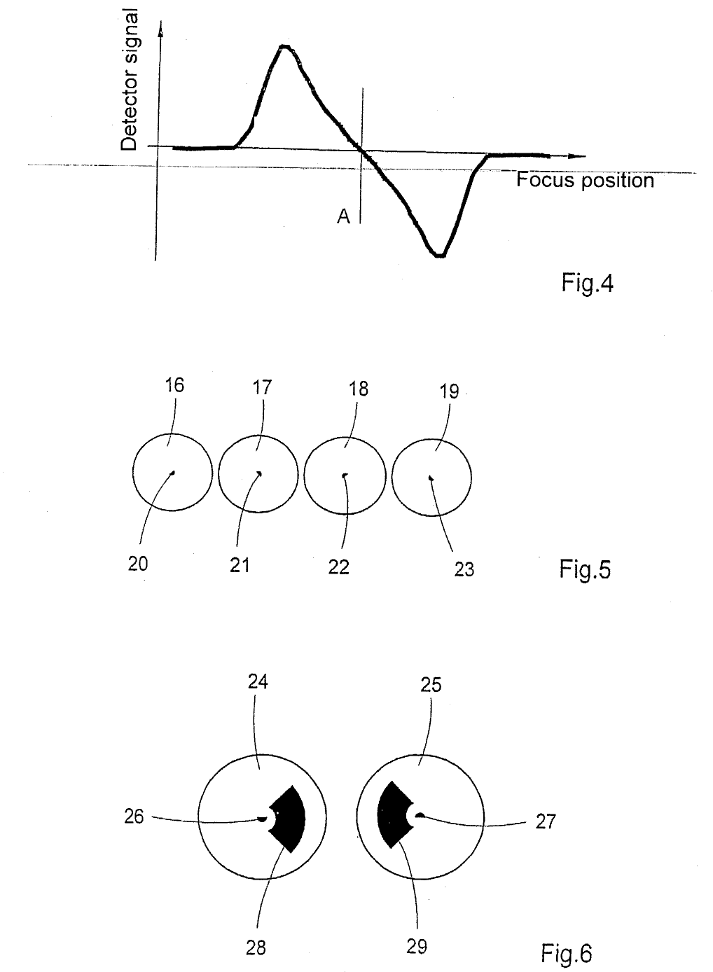

FIG. 4 shows the detector signal as a function of the focus position using two components with half-circular structures;

FIG. 5 shows the arrangement of four components provided with half-circular structures;

FIG. 6 shows the arrangement of two components which are provided, respectively, with two different structures;

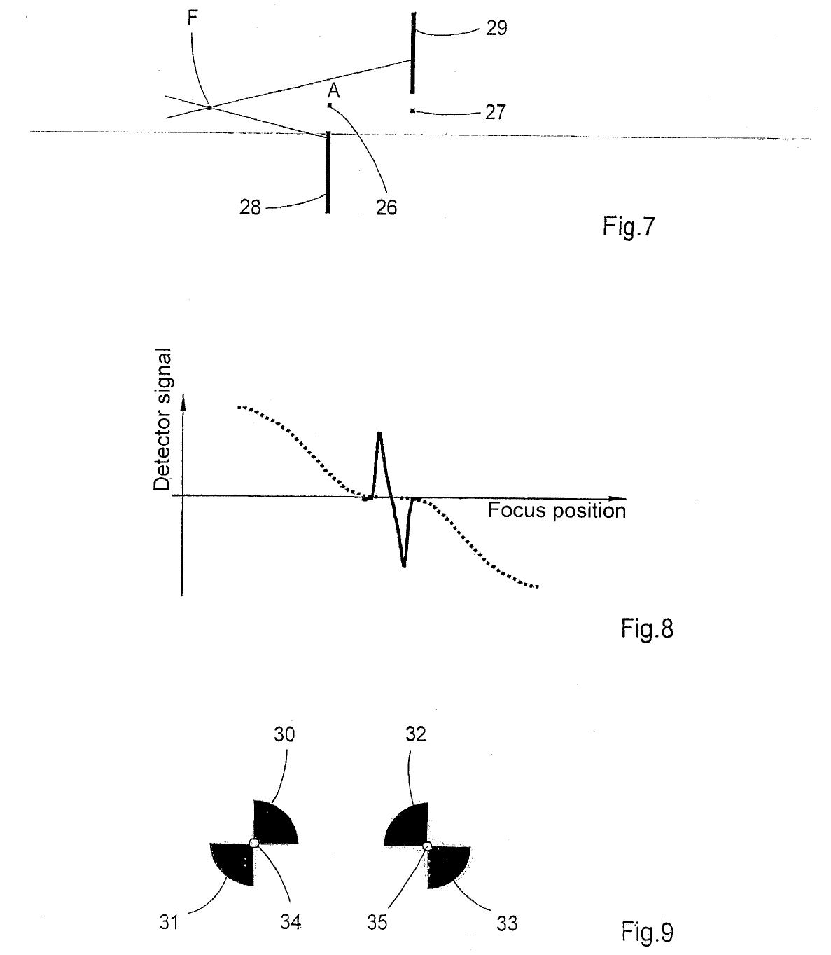

FIG. 7 shows an example of a beam path through two components with divergent focus positions;

FIG. 8 shows two detector signals as a function of the focus position;

FIG. 9 shows the arrangement of two components with two diametrically opposite quarter-circle segments, respectively;

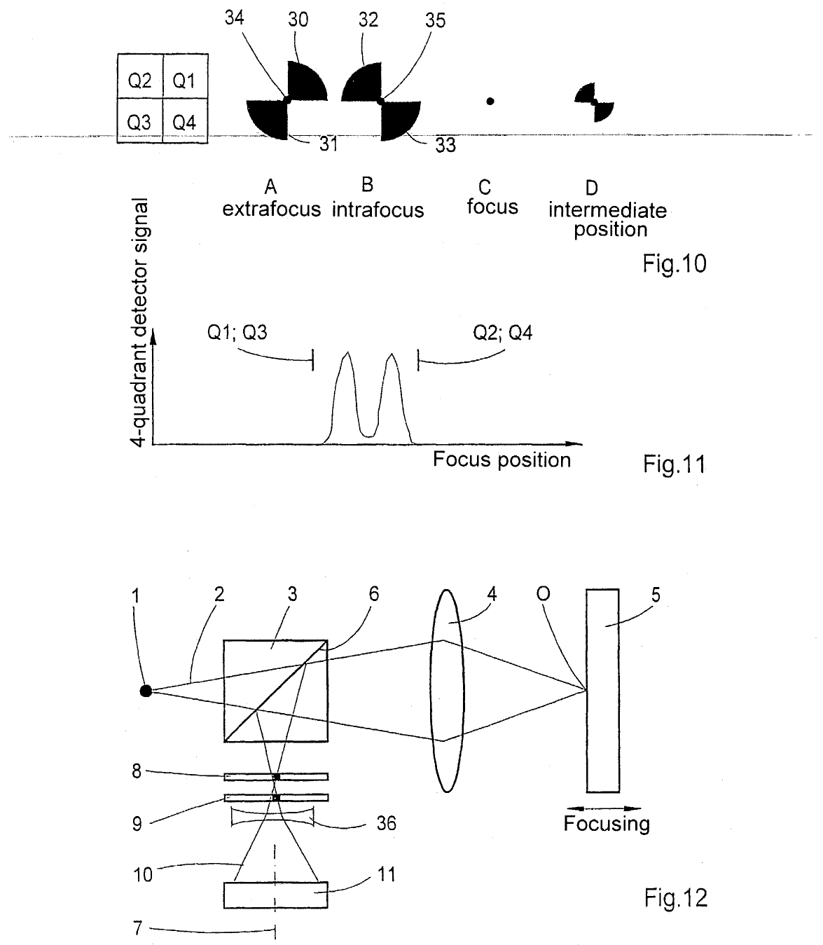

FIG. 10 shows schematically the detection of the focus position using a four-quadrant receiver as detector;

FIG. 11 shows an example of a four-quadrant signal as a function of the focus position;

FIG. 12 shows the basic construction of an autofocusing device making optimal use of the reception surface by incorporating a field lens.

FIG. 1 shows the basic construction of the arrangement according to the invention. The light beam 2 coming from a point-shaped illumination diaphragm 1 is directed through a beam splitter cube 3 via an imaging objective 4 onto an observed object 5. The laser light source which is provided for irradiating the illumination diaphragm 1 is not shown in the drawing.

The light reflected by the observed object 5 travels via the partially reflecting layer 6 of the beam splitter cube 3 to a measurement diaphragm arrangement comprising two inverted circular pinholes 8 and 9 which are arranged one behind the other in direction of the optical axis 7. A detector 11 is arranged following this measurement diaphragm arrangement.

Therefore, whenever the location of conjugation to the point light source approaches either pinhole 8 or pinhole 9 with a change in the focus position, the detection beam 10 is increasingly blocked. On the other hand, the detection beam 10 reaches the reception surface of the detector 11 with maximum intensity when the conjugation is located at exactly half of the distance between the two inverted pinholes 8 and 9.

The reason for this is that the light from the detection beam path 10 striking the inverted pinholes 8, 9 is blocked to a different extent in different focus positions.

FIG. 1 also shows a special construction in which the measurement diaphragm arrangement is arranged so as to be displaceable in direction of the optical axis, so that the autofocusing can be carried out on a plane lying outside of the observed location O. In this way, boundary layers which are better suited for autofocusing than the location O to be observed because of their optical characteristics can be used within a specimen for autofocusing.

FIG. 2 shows the detector signal with an ideal focus position A. The indicated intensity maximum I of the detector signal lies in focus position A. This is registered when the conjugation to the illumination diaphragm 1 is located at exactly half the distance between the inverted pinholes 8 and 9.

However, when the focus drifts, this arrangement does not supply any information about the direction in which this takes place because the intensity decreases to the same extent in the one Z-direction as in the other Z-direction, as can be seen from the slopes illustrated in FIG. 2. To this extent, an actuating direction to be given for refocusing can not be derived in this case.

In an advantageous further development of the invention in this connection, FIG. 3 shows a constructional variant in which two components 12 and 13 which have a half-circular structure 14 and 15 are provided instead of the inverted pinholes. The circle centers of the half-circular structures 14 and 15 are located on the optical axis 7. The components 12, 13 are arranged one behind the other in the detection beam path and, further, are so oriented with respect to one another that the half-circular structures 14, 15 are rotated by 180° about the optical axis from one component to the next. The half-circular structures 14, 15 are accordingly located opposite one another in a complementary manner and, when viewed in the direction of the optical axis 7, form a full circle with a diameter having the size of a pinhole, wherein a first half-circular structure 14 is located one length measurement in front of the position conjugate to the illumination diaphragm 1 in axial direction and the second half-circular structure 15 is located at the same length measurement behind the position conjugate to the illumination diaphragm 1. In an alternative construction, it is also possible that the half-circular structures 14, 15 lie at different distances in front of and behind the position conjugate to the illumination diaphragm 1, but are then at a distance from one another not greater than the depth of focus.

When the focus drifts, i.e., the location 0 observed on the object 5 is displaced (see FIG. 1) increasingly from the focus position in Z-direction, the maximum of the light spot or of the image of the point illuminated on the observed object 5 also drifts on the detector 11.

When the position conjugate to the illumination diaphragm 1 is displaced in the detection beam 10 toward the structure 14, one half of the beam is increasingly blocked; conversely, when the conjugate position is displaced in the detection beam path 10 toward structure 15 the other beam half is increasingly blocked.

A two-part position-sensitive detector 11 supplies a difference signal as is shown in FIG. 4. In the signal waveform shown in FIG. 4, the detector 11 is adjusted in such a way that the difference signal in the focus position A is equal to zero; the difference signal becomes greater during displacement in one direction and smaller during displacement in the opposite direction. The direction in which readjustment needs to be carried out in order to move the observed location O back into the focus position can be derived from this. The evaluation and readjustment can be carried out with devices known in the art, so that a more detailed description may be dispensed with in this connection.

FIG. 5 shows another constructional variant. In this case, four components 16, 17, 18, 19 are used, each of which has a half-circular structure 20, 21, 22, 23. The centers of the circles again lie in the optical axis 7. The components 16, 17, 18, 19 are arranged, according to the invention, one behind the other in the detector beam path 10 in such a way that, on the one hand, they lie at symmetrical distances from the location of the conjugation and, on the other hand, the structures 20, 21, 22, 23 are rotated relative to one another by 90°.

In this case, a four quadrant receiver is used as detector 11 and the signals can be detected easily for each of the two actuating devices.

In order to be able to achieve a high capture area with two optical components also, two components 24 and 25 are provided as is shown in FIG. 6. Each component 24 and 25 has a half-circular structure 26, 27 and an arc segment 28 and 29 arranged so as to be radially offset relative to the latter. These components 24 and 25 are arranged according to the invention in the same way as the variants already described, namely, so that, on the one hand, they lie at symmetrical distances in the beam path in front of and behind the location of conjugation and, on the other hand, the half-circular structures 26, 27 and the arc segments 28, 29 are rotated relative to one another by 180°. The centers of the circles lie on the optical axis 7 in each case.

The inner free surface portions of the arc-shaped structures 28, 29 are dimensioned in such a way that the detection beam path 10 is not yet blocked or has only just been blocked by the arc-shaped structure 29 of component 25 when the conjugation lies in the plane of the component 24. In this way, the arc-shaped structures 28, 29 only become optically active when the focus position or the conjugation has drifted so far that it is no longer located between the components 24, 25.

When the position F conjugate to the illumination diaphragm (1) is located outside of the components 24, 25 but closer to component 24, the beam diameter on component 24 is smaller than that on component 25.

In this case, a greater proportion of the detection beam path 10 is blocked by the arc-shaped structure 29 than by arc-shaped structure 28. This is also true when the conjugation has drifted so far that the arc-shaped structure 28 is already optically active. In this connection, the beam path is shown by way of example in FIG. 7.

FIG. 8 shows detection signals for fine focusing and coarse focusing depending on the focus position. When a four-quadrant receiver is used as detector 11, the fine focusing can be controlled via the center of gravity position of the light spot in one coordinate and the coarse focusing can be controlled via the center of gravity position of the light spot in the orthogonal coordinate.

FIG. 9 shows another construction of the invention which also provides for the use of two components. Each of these components has a circular structure 34, 35 the size of a point-shaped diaphragm or pinhole and two quarter-circle segments 30, 31; 32, 33 which are located diametrically opposite one another with respect to the optical axis. According to the invention, these components are arranged successively in such a way that the circle centers again lie in the optical axis and the quarter-circle segments are rotated by 90° about the optical axis from one component to the next.

The inner free diameter of the structures 30, 31, 32, 33 is dimensioned in such a way that the detection beam path 10 is blocked after about the Airy diameter and can therefore not reach the quadrants Q1, Q2, Q3, Q4 of the receiver. When the actual focus spot or the position conjugate to the illumination diaphragm 1 is located axially in the same position as the component with structures 30, 31, the detection beam path 10 penetrates the quarter-circle segments 30, 31 and reaches the quadrants Q1 and Q3, but is blocked by quarter-circle segments 32, 33 of the second component with respect to quadrants Q2 and Q4.

Conversely, when the light spot lies on structures 32, 33 of the second component, the detection beam path 10 is blocked by structures 30, 31 of the first component with respect to quadrants Q1 and Q3.

A signal waveform such as that shown in FIG. 11 results. The direction signal needed for focusing is obtained by the division of the light flow on the quadrant pair Q1, Q3 extrafocally and on quadrant pair Q2, Q4 intrafocally, because the ability to distinguish between the adjusting directions results from this.

When there are identical or substantially similar reflection coefficients at the observed object 5, the light intensity measured in the individual quadrants Q1, Q2, Q3, Q4 can also be used as a control variable for the degree of focus adjustment that is needed.

FIG. 12 shows the basic construction of the arrangement according to the invention in which, in addition to the arrangement shown in FIG. 1, a field lens 36 is located between components 8 and 9 for making optimal use of the reception surface of the detector 11.

Finally, the construction according to FIG. 12 also shows that the refocusing is provided not only, as in FIG. 1, by axial displacement of the imaging objective 4, but also can be carried out by adjusting the observed object 5 in Z-direction, which is more favorable in some applications.

Reference Numbers

1 illumination source

2 light beam

3 beam splitter cube

4 imaging objective

5 observed object

6 partially reflecting layer

7 optical axis

8, 9 pinholes

10 detection beam path

11 detector

12, 13 inverted pinholes

14, 15 half-circular structures

16, 17, 18, 19 inverted pinholes

20, 21, 22, 23 half-circular structures

24, 25 inverted pinholes

26, 27 half-circular structures

28, 29 circle segment-shaped structures

30, 31, 32, 33 quarter circle-shaped structures

34, 35 quarter pinholes

36 field lens

O location

F conjugate position

1. Autofocusing device for optical instruments, preferably for microscopes for wafer inspection, in which a point-shaped illumination diaphragm (1) which is illuminated by laser light is imaged in an observed object (5) by means of an imaging objective (4), wherein an image of the point illuminated on the observed object (5) is formed in a measurement diaphragm arrangement conjugate to the illumination diaphragm (1), the position of maximum intensity of this image is determined by a position-sensitive detector (11) and this position is compared to a position corresponding to the focus position, and an actuating signal for autofocusing is obtained from the deviation between the two positions, characterized in that the measurement diaphragm arrangement comprises a plurality of optically active components which are arranged one behind the other in axial direction and have partially transparent and partially opaque structures which complement one another, and the components are arranged in the beam path in front of and behind the position conjugate to the illumination diaphragm (1) within a distance from one another corresponding to the depth of focus, wherein the cross section of the light beam coming from the observed object (5) is blocked by the structures to a greater or lesser extent depending on the position of the observed object (5), and therefore the intensity of the image on the detector (11) has a definite distribution when the deviation in position approaches zero or when the observed object (5) is located in the focus position.

2. Autofocusing device according to claim 1, characterized in that two components (8, 9) are provided, each of which has a circular structure having the size of a point-shaped diaphragm or pinhole, whose centers lie in the optical axis (7), wherein the structure of a first one of the two components is opaque and the area surrounding it is transparent.

3. Autofocusing device according to claim 1, characterized in that two components (12, 13) are provided, each of which has a circular structure having the size of a point-shaped diaphragm or pinhole, whose centers lie in the optical axis (7), wherein a half-circle (14, 15) of each of these structures is transparent and the second half-circle of each of these structures is opaque, and wherein the structures are rotated by 180° about the optical axis (7) from one component to the next.

4. Autofocusing device according to claim 1, characterized in that four components (16, 17, 18, 19) are provided, each of which has a circular structure having the size of a point-shaped diaphragm or pinhole, whose centers lie in the optical axis (7), wherein one half-circle (20, 21, 22, 23) of each of these structures is transparent and one half-circle is opaque, and wherein the structures are rotated by 90° about the optical axis (7) from component to component.

5. Autofocusing device according to claim 1, characterized in that two components (24, 25) are provided, each of which has opaque structures in the form of a half-circle (26, 27) and an arc segment (28, 29) which is arranged so as to be radially offset relative to the latter, wherein the circle centers always lie in the optical axis, and wherein the structures are oriented so as to be rotated by 180° about the optical axis from one component to the next.

6. Autofocusing device according to claim 1, characterized in that two components are provided, each of which has a circular structure (34, 35) having the size of a point-shaped diaphragm or of a pinhole and has two quarter-circle segments (30, 31; 32, 33) located diametrically opposite one another, wherein the circle centers always lie in the optical axis, and wherein the quarter-circle segments are oriented so as to be rotated by 90° about the optical axis from one component to the next.

7. Autofocusing device according to one of the preceding claims, characterized in that a four-quadrant detector is provided as detector (11).

8. Autofocusing device according to one of the preceding claims, characterized in that light-deflecting elements such as prisms and/or gratings are provided as structures.

9. Autofocusing device according to one of the preceding claims, characterized in that selective elements such as polarization filters and/or wavelength filters are provided as structures.

10. Autofocusing device according to one of the preceding claims, characterized in that the signal outputs of the detector (11) are connected, via an evaluating unit, to an actuating device for changing the position of the observed object (5) in the Z-coordinate and, accordingly, for correcting the focus position.

11. Autofocusing device according to one of the preceding claims, characterized in that a field lens (36) is arranged between the measurement diaphragm arrangement and the detector (11).

12. Autofocusing device according to one of the preceding claims, characterized in that the measurement diaphragm arrangement is arranged so as to be displaceable in direction of the optical axis (7), so that the autofocusing is carried out on a plane lying outside of the observed location O.
